(19) United States
(12) Patent Application Publication
(10) Pub. No.: US 2024/0416571 A1
(43) Pub. Date: Dec. 19, 2024

(54) CONNECTING TUBE ASSEMBLY FOR AN EXTRUDER

(71) Applicant: BASF SE, Ludwigshafen (DE)

(72) Inventors: Kay Koppelt, Schwarzheide (DE); Robert Socher, Schwarzheide (DE); Marco Kenne, Schwarzheide (DE); Mario Schwabe, Schwarzheide (DE); Michael Tritschler, Schwarzheide (DE)

(21) Appl. No.: 18/697,636

(22) PCT Filed: Oct. 6, 2022
(86) PCT No.: PCT/EP2022/077795

§ 371 Date: Apr. 1, 2024

(30) Foreign Application Priority Data
Oct. 6, 2021 (DE) 10 2021 211 271.4

(51) Int. Cl. B29C 48/50; B29C 48/285; B29C 48/92; B29K 509/08

(52) U.S. Cl. CPC B29C 48/501; B29C 48/286; B29C 48/288; B29C 48/92; B29C 2948/9218; B29C 2948/92333; B29K 2509/08

(57) ABSTRACT

A connecting tube assembly (128) for an extruder (110) is proposed. The connecting tube assembly (128) comprises a connecting tube (130), wherein the connecting tube (130) is configured for connecting to a dosing conveyor device (118) and a side feed (126) of the extruder (110), wherein the connecting tube (130) defines a longitudinal axis (132), and a drive device (142), wherein the drive device (142) is configured for rotating the connecting tube (130) about the longitudinal axis (132). Furthermore, an extruder (110) is proposed.

The invention relates to a connecting tube assembly for an extruder and to an extruder.

Components made of fiber-reinforced plastics are used for many applications. Components made of fiber-reinforced plastics have a multiplicity of advantages over metal parts, such as weight savings, corrosion resistance and failure reliability, and are therefore increasingly used in industry and research. Fiber-reinforced plastics contain as essential components a matrix system made of plastic, into which reinforcing fibers, for example based on glass, carbon, aramid or nylon, are embedded.

Extruders can be used to manufacture fiber-reinforced components. During extrusion, solid to viscous curable masses are pressed out continuously under pressure from a shaping opening, also known as a nozzle, die or mouthpiece. In this process, bodies with the cross section of the opening, called extrudates, are formed in theoretically arbitrary lengths. In order to produce fiber-reinforced components made of plastic by means of an extruder, fibers, such as glass fibers, are continuously added to a plastic main stream conveyed by the extruder via an auxiliary connection of the extruder. For this purpose, the auxiliary connection is usually connected by means of a connecting tube with a dosing scale for dosing and conveying the fibers as an additive. The connecting tube is a downpipe and is oriented parallel to the direction of gravity. The dosing scale has a conveying section oriented perpendicular to the direction of gravity, by means of which a continuous product flow of the fibers is conveyed into the connecting tube.

In practice, it has been shown that, due to the transition of the horizontal conveying into the vertically oriented connecting tube, one-sided deposits occur inside the connecting tube, while the other side is continuously cleaned by the glass fiber flow. The inside of the pipe, which is not cleaned by the falling product flow, is also called the “shadow side”. These deposits of the glass fibers grow over time until they become too heavy and fall down. Such falling deposits can disrupt or interrupt the manufacturing process, for example by blocking the connecting tube or overloading the extruder due to a high amount of glass fibers, which is also called falling glass. So far, the connecting tube has therefore to be cleaned, for example at regular intervals. During cleaning, the extrusion process must be interrupted. Such interruptions to the extrusion process result in reduced throughput, waste of material and scrap. In addition, quality problems can occur because a high amount of glass fibers in the extruder cannot be dispersed well.

DE 10 2013 212 167 A1 discloses a device and a method for introducing fibers into an extruder.

DE 10 2007 061 620 A1 discloses a method for the production of agglomerate-free natural and synthetic fiber-reinforced polymer melts and thermoplastic semi-finished products via direct processing of continuous fibers.

WO 2009/099 920 A2 discloses plastic composites using recycled carpet waste and systems and methods for recycling carpet waste.

DE 102 01 869 A1 discloses a feeding device for shavings and short-cut fibers.

DE 10 2007 047 548 A1 discloses a device for feeding fibers.

It is therefore an object of the present invention to at least largely avoid the disadvantages of known devices and extrusion methods. In particular, deposits should be prevented in a connecting tube of an extruder.

This object is solved by a connecting tube assembly and an extruder with the features of the independent patent claims. Advantageous embodiments which can be realized in isolation or in any combination are listed in the dependent claims.

In the following, the terms “have”, “exhibit”, “comprise” or “include” or any grammatical deviations from them are used in a non-exclusive manner. Accordingly, these terms may refer both to situations in which, in addition to the feature introduced by these terms, there are no other features, or to situations in which one or more other features exist. For example, the expression “A has B”, “A exhibits B”, “A comprises B” or “A includes B” may relate both to the situation in which, apart from B, there is no further element in A (i.e. to a situation in which A exclusively consists of B) and to the situation in which, in addition to B, there is or are one or more further elements in A, for example element C, elements C and D or even further elements.

It is also pointed out that the terms “at least one” and “one or more” and grammatical variations of these terms or similar terms, when they are used in connection with one or more elements or features and are intended to express that the element or feature may be provided one or more times, are generally only used once, for example when the feature or element is introduced for the first time. When the feature or element is subsequently mentioned again, the corresponding term “at least one” or “one or more” is generally no longer used, without restricting the possibility that the feature or element may be provided one or more times. Furthermore, the terms “preferably”, “in particular”, “for example” or similar terms are used hereinafter in connection with optional features, without alternative embodiments being restricted thereby. Thus, features, the description of which is introduced by these terms, are optional features, and it is not intended to restrict the scope of protection of the claims, and in particular of the independent claims, by these features. Thus, the invention, as a person skilled in the art will recognize, can also be carried out using other embodiments. Similarly, features introduced by “in one embodiment of the invention” or “in one example of the invention” are understood as optional features without limiting alternative embodiments or the scope of protection of the independent claims. Furthermore, all the possible combinations of the features thereby introduced with other features, whether optional or non-optional features, shall remain unaffected by these introductory expressions.

In a first aspect, a connecting tube assembly for an extruder is proposed. The connecting tube assembly comprises a connecting tube. The connecting tube is configured for connecting to a dosing conveyor device and a side feed of the extruder. The connecting tube defines a longitudinal axis. The connecting tube assembly also comprises a drive device. The drive device is configured for rotating the connecting tube around the longitudinal axis.

The connecting tube allows a feed of a solid additive from a dosing conveyor device to a side feed of the extruder in the connected state. By the rotational movement of the connecting tube caused by the drive device, the additive flow conveyed through the connecting tube causes the additive to reach the inner wall of the connecting tube on all sides and thus to detach additive adhering to it by this contact. Thus, the formation of a solid layer of an additive, such as glass fibers, on the inner wall of the connecting tube can be prevented. In other words, a kind of self-cleaning is realized by the rotational movement of the connecting tube. This makes the dosage of the additive to the main flow conveyed in the extruder more uniform. In addition, such a connecting tube assembly can also be retrofitted in existing systems or extruders.

The connecting tube may have a polygonal, square, triangular, elliptical or circular cross section. Accordingly, the connecting tube can fundamentally have any cross-sectional shape. Here, however, a circular cross section is preferred, since this develops the previously described self-cleaning effect more clearly in comparison to an angular design.

The connecting tube may have a length which is greater by at least a factor of 5 and preferably at least a factor of 8 than a diameter of the pipe. Accordingly, the connecting tube also allows the additive to be conveyed over relatively long distances.

The connecting tube can be at least partially produced from metal. This makes the connecting tube suitable for many types of additives.

The drive device may be configured for turning the connecting tube at from 0.5 revolutions per minute to 20 revolutions per minute, preferably from 1 revolution per minute to 10 revolutions and still more preferably from 2 revolutions per minute to 5 revolutions per minute. Accordingly, the self-cleaning effect described above is achieved at comparatively low speeds, with the result that this can also be achieved with comparatively low energy expenditure.

The drive device may be configured for continuous rotation of the connecting tube. Thus, the dosage of the additive to the main flow conveyed in the extruder and the self-cleaning effect described above are uniformly developed.

The connecting tube may have an output wheel. The drive device may have a drive wheel. The drive wheel and the output wheel can be connected so as to rotate together. This allows the connecting tube to be rotated particularly effectively.

The output wheel may be arranged on an outer surface of the connecting tube. This makes it particularly easy to connect the connecting tube to the drive device.

Furthermore, the connecting tube assembly can comprise a housing. The housing can at least partially and preferably completely surround the output wheel and the drive wheel. This can prevent a person from getting into the running drive device with their hand or another part of the body, which increases occupational safety. For reasons of occupational safety, such a housing may therefore be prescribed, but is not a mandatory component for the function of the connecting tube assembly, but rather optional.

The drive device may have a motor. This makes it particularly easy and effective to drive the connecting tube for rotation.

In another aspect, an extruder is proposed. The extruder comprises a dosing conveyor device, a side feed and a connecting tube assembly according to one of the embodiments described above or explained in greater detail below. The connecting tube is connected to the dosing conveyor device and the side feed of the extruder. Such an extruder has the advantages described above. In particular, it no longer needs to be interrupted in its production process for cleaning purposes of the connecting tube.

The connecting tube can be arranged substantially parallel to the direction of gravity. Thus, the connecting tube can be designed as a kind of downpipe that causes the conveying of an additive exclusively by gravity and without its own conveyor device.

The dosing conveyor device may be configured for continuous conveying of an additive stream of a solid additive. This allows the additive to be added uniformly to the extrusion compound.

The dosing conveyor device may be configured for continuous conveying of glass fibers. Such glass fibers tend to accumulate on an inner wall of the connecting tube due to electrostatic charge. However, by the rotational movement of the connecting tube, the above-described self-cleaning effect is achieved, with the result that there is no longer any shadow side in the connecting tube and deposits in other places.

The dosing conveyor device may have a scale for weighing a solid additive and a screw conveyor for conveying the additive. This allows an exact dosage of the additive to be realized.

The term “extruder” as used here is a broad term to which its usual and common meaning, as understood by a person skilled in the art, is to be attached. The term is not restricted to a specific or adapted meaning. The term may, without limitation, refer in particular to a machine for the manufacture of molded parts from thermoplastic material. Extruders are conveyors that, according to the operating principle of the Archimedean screw, press solid to viscous masses uniformly out of a shaping opening, also known as a nozzle, die or mouthpiece, under high pressure and high temperature. In this process, bodies with the cross section of the opening, called extrudates, are formed in theoretically arbitrary lengths.

This method is called extrusion. In principle, extruders can be divided into 2 process principles: Processing and compounding extruders. Processing extruders are mainly used for shaping (usually single-shaft extruders), while compounding extruders are used for chemical and/or physical modification (reaction, mixing, degassing, etc.) of materials (synchronous, tightly meshed double-shaft extruders, Buss kneaders, etc.). There are extruders with one, two or more screw shafts. In the case of extruders with two screws, a distinction is made between the co-rotating and the counter-rotating twin screw extruder. In the case of a co-rotating twin-screw extruder, the screws rotate in the same direction of rotation and, in the case of a counter-rotating twin-screw extruder, in the opposite direction of rotation. The conveying and pressure build-up of the single-screw and co-rotating twin-screw extruder are effected by the friction of the mass rotating with the screw on the stationary housing wall (cylinder)-in this context, this is referred to as friction conveying. The mass remaining in rotation in this way is pushed by the helical screw spirals to the outlet nozzle. In the case of the counter-rotating twin-screw extruder, the principle of forced conveying prevails.

The term “extruder side feed” as used here is a broad term to which its usual and common meaning, as understood by a person skilled in the art, is to be attached. The term is not restricted to a specific or adapted meaning. The term can, without limitation, refer in particular to a device which, by means of a conveyor device, such as in the form of screw shafts, which are driven by a motor, conveys the additive falling through the downpipe laterally into the (main) extruder. The side feed is connected to this end to an auxiliary supply connection of the extruder, by means of which the additive can be added to the (main) product stream of the extrusion compound conveyed in the interior. This type of supply of such an additive is also referred to as side feeding or a side feeding device. Accordingly, the term is also used synonymously to the extruder's side feed device.

The term “dosing conveyor device” as used here is a broad term to which its usual and common meaning, as understood by a person skilled in the art, is to be attached. The term is not restricted to a specific or adapted meaning. The term may, without limitation, refer in particular to a device which is designed for dosing and conveying a predetermined amount of an additive. For this purpose, the dosing conveyor device has a conveyor device, such as a screw conveyor, and comprises a scale or is connected to a scale to determine or measure the amount of the additive.

The term “connecting tube” as used here is a broad term to which its usual and common meaning, as understood by a person skilled in the art, is to be attached. The term is not restricted to a specific or adapted meaning. The term may, without limitation, refer in particular to a tube which is configured for connecting to a dosing conveyor device and a side feed of the extruder. When connected, the connecting tube is usually oriented substantially parallel to the direction of gravity. Thus, the connecting tube acts as a downpipe in the connected state.

The term “substantially parallel to the direction of gravity” as used herein is a broad term to which its ordinary and common meaning, as understood by a person skilled in the art, is to be attached. The term is not restricted to a specific or adapted meaning. The term can, without limitation, refer in particular to an orientation of the connecting tube which deviates by not more than 15°, preferably not more than 10° and still more preferably not more than 5° from an exactly parallel orientation to the direction of gravity.

The term “longitudinal axis” as used here is a broad term to which its usual and common meaning, as understood by a person skilled in the art, is to be attached. The term is not restricted to a specific or adapted meaning. The term may, without limitation, refer in particular to an axis parallel to or along a longest dimension of a component. The component can be configured here to be rotationally symmetrical around the longitudinal axis, but geometries that deviate from this are also possible.

The term “continuous rotation of the connecting tube” as used here is a broad term to which its usual and common meaning, as understood by a person skilled in the art, is to be attached. The term is not restricted to a specific or adapted meaning. The term may, without limitation, refer in particular to a rotational movement of the connecting tube without stopping or interruption. The rotational speed preferably remains constant here.

The term “drive device” as used here is a broad term to which its usual and common meaning, as understood by a person skilled in the art, is to be attached. The term is not restricted to a specific or adapted meaning. The term may, without limitation, refer in particular to a power machine which is designed to cause a rotational movement of a component. In particular, the term may refer to a power machine which is configured to rotate the connecting tube around its longitudinal axis. For this purpose, the drive device may have a motor or be configured as a motor. In particular, the drive device may have an electric motor or be configured as an electric motor.

The term “drive wheel” as used here is a broad term to which its usual and common meaning, as understood by a person skilled in the art, is to be attached. The term is not restricted to a specific or adapted meaning. The term may, without limitation, refer in particular to a driving wheel that causes a drive. The driving force of the drive wheel is generated by a power machine. Thus, the drive wheel is actively rotated by the power machine to exert the driving force on another component that is driven.

The term “output wheel” as used here is a broad term to which its usual and common meaning, as understood by a person skilled in the art, is to be attached. The term is not restricted to a specific or adapted meaning. The term can, without limitation, refer in particular to a driven wheel, i.e. a wheel that is rotated by another component. The term output is used in particular to refer to the position of the power machine at which it outputs mechanical work on the work machine (e.g. the protruding end of a motor shaft or the output shaft of a gearbox). The transferring machine element is a coupling or a V-belt.

The term “additive” as used here is a broad term to which its usual and common meaning, as understood by a person skilled in the art, is to be attached. The term is not restricted to a specific or adapted meaning. The term can, without limitation, refer in particular to a solid that is added to a main product stream in an extruder. This can basically be any conveyable solid material, such as powder, granulate or fibers. In the context of the present invention, the term may preferably refer to fibers and, in particular, glass fibers.

The term “swivel drive” as used here is a broad term to which its usual and common meaning, as understood by a person skilled in the art, is to be attached. The term is not restricted to a specific or adapted meaning. The term can, without limitation, refer in particular to a ready-to-install system assembly consisting of a ball or roller rotary connection for the simultaneous absorption of axial and radial forces as well as tilting torques with hydraulic or electrical drives in a completely enclosing housing. Swivel drives usually consist of a rotating ball joint and a drive worm surrounded by a housing.

In summary, without limiting further possible embodiments, the following embodiments are proposed:
Embodiment 1: A connecting tube assembly for an extruder, comprising a connecting tube, wherein the connecting tube is configured for connecting to a dosing conveyor device and a side feed of the extruder, wherein the connecting tube defines a longitudinal axis, and a drive device, wherein the drive device is configured for rotating the connecting tube about the longitudinal axis.
Embodiment 2: The connecting tube assembly according to the preceding embodiment, wherein the connecting tube has a polygonal, square, triangular, elliptical or circular cross section.
Embodiment 3: The connecting tube assembly according to one of the preceding embodiments, wherein the connecting tube has a length which is greater by at least a factor of 5 and preferably at least a factor of 8 than a diameter of the tube.
Embodiment 4: The connecting tube assembly according to one of the preceding embodiments, wherein the connecting tube is at least partially produced from metal.
Embodiment 5: The connecting tube assembly according to one of the preceding embodiments, wherein the drive device is configured for turning the connecting tube at from 0.5 revolutions per minute to 20 revolutions per minute, preferably from 1 revolution per minute to 10 revolutions and still more preferably from 2 revolutions per minute to 5 revolutions per minute.
Embodiment 6: The connecting tube assembly according to one of the preceding embodiments, wherein the drive device is configured for continuous rotation of the connecting tube.
Embodiment 7: The connecting tube assembly according to one of the preceding embodiments, wherein the connecting tube has an output wheel, wherein the drive device has a drive wheel, wherein the drive wheel and the output wheel are rotationally connected.
Embodiment 8: The connecting tube assembly according to the preceding embodiment, wherein the output wheel is arranged on an outer surface of the connecting tube.
Embodiment 9: The connecting tube assembly according to either of the two preceding embodiments, further comprising a housing, wherein the housing surrounds the output wheel and the drive wheel at least partially and preferably completely.
Embodiment 10: The connecting tube assembly according to any one of the preceding embodiments, wherein the drive device has a motor or is configured as a motor.
Embodiment 11: An extruder comprising a dosing conveyor device, a side feed and a connecting tube assembly according to any one of the preceding embodiments, wherein the connecting tube is connected to the dosing conveyor device and the side feed of the extruder.
Embodiment 12: The extruder according to the preceding embodiment, wherein the connecting tube is arranged substantially parallel to the direction of gravity.
Embodiment 13: The extruder according to embodiment 11 or 12, wherein the dosing conveying device is configured for continuous conveying of an additive stream of a solid additive.
Embodiment 14: The extruder according to one of the embodiments 11 to 13, wherein the dosing conveyor device is configured for continuous conveying of glass fibers.
Embodiment 15: The extruder according to any one of the embodiments 11 to 14, wherein the dosing conveyor device has a scale for weighing a solid additive and a screw conveyor for conveying the additive.

### BRIEF DESCRIPTION OF THE FIGURES

Further details and features will become apparent from the following description of examples, in particular in connection with the dependent claims. The respective features may in this case be implemented on their own, or two or more may be implemented in combination with one another. The invention is not restricted to the examples. The examples are illustrated diagrammatically in the figures. Identical designations in the individual figures relate to elements that are the same or have the same function, or correspond to one another in terms of their functions.

In the drawing:

FIG. 1 shows a perspective view of an extruder according to one embodiment of the present invention.

### DESCRIPTION OF THE EXAMPLES

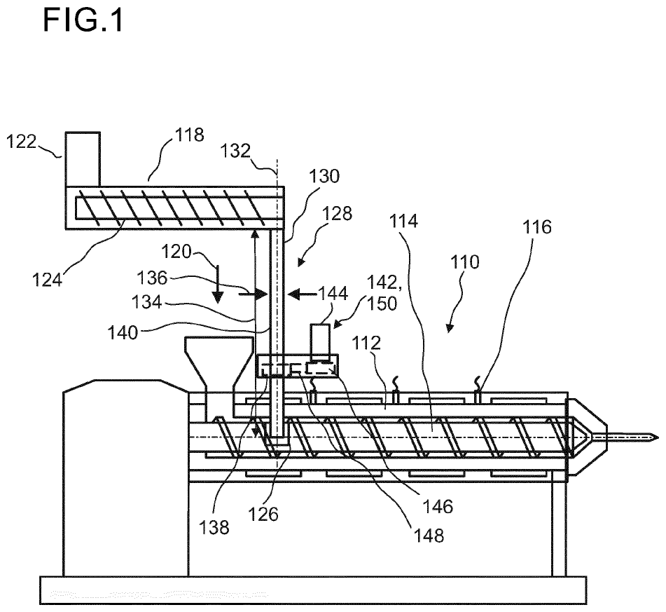

FIG. 1 shows a perspective view of an extruder 110 according to one embodiment of the present invention. The extruder 110 has an extruder cylinder 112 with at least one extruder screw 114 arranged therein. The extruder cylinder 112 is configured in the embodiment shown as an extruder housing 116 and may comprise further components, such as an insulation or heating shell.

The extruder 110 further comprises a dosing conveyor device 118. The dosing conveyor device 118 extends substantially perpendicularly to a direction of gravity 120. The dosing conveyor device 118 is configured for continuous conveying of an additive stream of a solid additive. In the embodiment shown, the dosing conveyor device 118 is configured as a differential dosing scale. The dosing conveyor device 118 has a scale 122 for weighing a solid additive and a screw conveyor 124 for conveying the additive. In the embodiment shown, the dosing conveyor device 118 is configured for the continuous conveying of glass fibers. The glass fibers are accordingly the additive.

The extruder 110 has, furthermore, a side feed 126. The side feed 126 is arranged laterally on the extruder cylinder 112 and allows the additive to be fed to the extrusion material conveyed in the extruder cylinder 112 of the extruder 110 via a side or auxiliary supply connection (not shown in greater detail) of the extruder 110. The extrusion compound may be plastic, such as a thermoplastic.

The extruder 110 has, furthermore, a connecting tube assembly 128. The connecting tube assembly 128 comprises a connecting tube 130. The connecting tube 130 is configured for connecting to the dosing conveyor device 118 and the side feed 126 of the extruder 110. FIG. 1 shows the connecting tube 130 in the connected state. Accordingly, FIG. 1 shows that the connecting tube 130 is connected to the dosing conveyor device 118 and the side feed 126 of the extruder 110. In this connected state, the connecting tube 130 is oriented substantially parallel to the direction of gravity 120. The connecting tube 130 defines a longitudinal axis 132. The connecting tube 130 can in principle have a polygonal, square, triangular, elliptical or circular cross section. In the embodiment shown, the connecting tube 130 has a circular cross section. The connecting tube 130 has a length 134 which is greater by at least a factor of 5 and preferably at least a factor of 8 than a diameter 136 of the connecting tube 130, for example a factor of 10 or 15. The connecting tube 130 is at least partially produced from metal. The connecting tube 130 has an output wheel 138. The output wheel 138 is arranged on an outer surface 140 of the connecting tube 130.

The connecting tube assembly 128 further comprises a drive device 142. The drive device 142 is configured for rotating the connecting tube 130 about the longitudinal axis 132. The drive device 142 has a motor 144. In the embodiment shown, the motor 144 is configured as an electric motor. The drive device 142 has a drive wheel 146. The drive wheel 146 and the output wheel 138 of the connecting tube 130 are rotationally connected. In the embodiment shown, the drive device 142 is formed as a swivel drive 148. Accordingly, the output wheel 138 and the drive wheel 146 are configured as gearwheels. However, it is explicitly emphasized that the output wheel 138 and the drive wheel 146 can alternatively be rotationally connected by means of a V-belt or the like. The extruder 110 further comprises a housing 148 which surrounds the output wheel 138 and the drive wheel 146 and the V-belt 148 at least partially and preferably completely. In the embodiment shown, the drive device 142 is configured as a swivel drive 150. Accordingly, the output wheel 138 and the drive wheel 146 are configured as gearwheels. However, it is explicitly emphasized that the output wheel 138 and the drive wheel 146 can alternatively be rotationally connected by means of a V-belt or the like. The drive device 142 is designed for turning the connecting tube 130 at from 0.5 revolutions per minute to 20 revolutions per minute, preferably from 1 revolution per minute to 10 revolutions and even more preferably from 2 revolutions per minute to 5 revolutions per minute, such as at 3 revolutions per minute. In particular, the drive device 142 is designed for continuous rotation of the connecting tube 130.

The operation of the extruder 110 is described in more detail below. The extruder 110 is used to produce a component. For this purpose, as it is generally known, an extrusion compound is conveyed in the extruder cylinder 112, which exits as an extrudate at the nozzle opening of the extruder 110. To adjust certain properties of the extrudate, an additive in the form of glass fibers is added to the extrusion compound. For this purpose, a predetermined amount of glass fibers is weighed by means of the scale 122 of the dosing conveyor device 118 and continuously transported into the connecting tube 130 by means of the screw conveyor 124 of the dosing conveyor device 118. The predetermined quantity and the conveying speed of the glass fibers depend on the formulation for the component to be manufactured or on the process parameters. There, the glass fibers fall due to gravity through the connecting tube 130 and thus enter the side feed 126. This conveys the additive (glass fibers) that has fallen down through the connecting tube 130 by means of their screw conveyors (via or through the auxiliary supply connection) into the extruder. In this way, the glass fibers are fed to the extrusion compound via the side feed 126 and the auxiliary supply connection of the extruder 110, where the glass fibers are mixed with it. During the transition from the dosing conveying device 118 oriented vertically with respect to the direction of gravity 120 or horizontally to the connecting tube 130 oriented vertical or parallel to the direction of gravity 120, the glass fibers can deposit on one side on the inner wall of the connecting tube 130 and, if necessary, detach as lumps or glass fiber mats due to electrostatic charging. To prevent this deposition of glass fibers, the drive device 142 drives the connecting tube 130 continuously at a speed of, for example, from 2 to 3 revolutions per minute for rotation around the longitudinal axis 132. As a result, the glass fibers are conveyed along all sides of the inner wall of the connecting tube 130 and, if necessary, peel off adhering glass fibers before they can form a larger accumulation, film or glass fiber mat. This enables continuous and even delivery of the glass fibers to the extrusion compound in the extruder 110.

### LIST OF DESIGNATIONS

110 Extruder
112 Extruder cylinder
114 Extruder screw
116 Extruder housing
118 Dosing conveyor device
120 Direction of gravity
122 Scale
124 Screw conveyor
126 Side feed
128 Connecting tube assembly
130 Connecting tube
132 Longitudinal axis
134 Length
136 Diameter
138 Output wheel
140 Outer surface
142 Drive device
144 Motor
146 Drive wheel
148 Housing
150 Swivel drive

1. A connecting tube assembly (128) for an extruder (110), comprising
a connecting tube (130), wherein the connecting tube (130) is configured for connecting to a dosing conveyor device (118) and a side feed (126) of the extruder (110), wherein the connecting tube (130) defines a longitudinal axis (132), and
a drive device (142), wherein the drive device (142) is configured for rotating the connecting tube (130) about the longitudinal axis (132).

2. The connecting tube assembly (128) as claimed in claim 1, wherein the connecting tube (130) has a polygonal, square, triangular, elliptical, or circular cross section.

3. The connecting tube assembly (128) as claimed in claim 1, wherein the connecting tube (130) has a length (134) which is greater by at least a factor of 5 than a diameter (136) of the connecting tube (130).

4. The connecting tube assembly (128) as claimed in claim 1, wherein the connecting tube (130) is at least partially produced from metal.

5. The connecting tube assembly (128) as claimed in claim 1, wherein the drive device (142) is configured for turning the connecting tube (130) at from 0.5 revolutions per minute to 20 revolutions per minute.

6. The connecting tube assembly (128) as claimed in claim 1, wherein the drive device (142) is configured for continuous rotation of the connecting tube (130).

7. The connecting tube assembly (128) as claimed in claim 1, wherein the connecting tube (130) has an output wheel (138), wherein the drive device (142) has a drive wheel (146), wherein the drive wheel (146) and the output wheel (138) are rotationally connected.

8. The connecting tube assembly (128) as claimed in claim 1, wherein the output wheel (138) is arranged on an outer surface (140) of the connecting tube (130).

9. The connecting tube assembly (128) as claimed in claim 7, further comprising a housing (148), wherein the housing (148) surrounds the output wheel (138) and the drive wheel (146) at least partially and preferably completely.

10. The connecting tube assembly (128) as claimed in claim 1, wherein the drive device (142) has a motor (144).

11. An extruder (110), comprising a dosing conveyor device (118), a side feed (126), and a connecting tube assembly (128) as claimed in claim 1, wherein the connecting tube (130) is connected to the dosing conveyor device (118) and the side feed (126) of the extruder (110).

12. The extruder (110) as claimed in claim 11, wherein the connecting tube (130) is arranged substantially parallel to the direction of gravity (120).

13. The extruder (110) as claimed in claim 11, wherein the dosing conveyor device (118) is configured for continuous conveying of an additive stream of a solid additive.

14. The extruder (110) as claimed in claim 11, wherein the dosing conveyor device (118) is configured for continuous conveying of glass fibers.

15. The extruder (110) as claimed in claim 11, wherein the dosing conveyor device (118) has a scale (122) for weighing a solid additive and a screw conveyor (124) for conveying the additive.
